(19) United States
(12) Patent Application Publication
(10) Pub. No.: US 2021/0389807 A1
(43) Pub. Date: Dec. 16, 2021

(54) Capacitance Sensing Strip

(71) Applicant: Cirque Corporation, Sandy, UT (US)

(72) Inventors: Brian Monson, Farmington, UT (US); Ethan Sturm, Salt Lake City, UT (US)

(73) Assignee: Cirque Corporation, Sandy, UT (US)

(21) Appl. No.: 16/897,739

(22) Filed: Jun. 10, 2020

(51) Int. Cl. G06F 1/16; G06F 3/0354; G06F 3/0488

(52) U.S. Cl. CPC G06F 1/1662; G06F 1/1626; G06F 2203/0339; G06F 3/03547; G06F 3/04883; G06F 1/169

(57) ABSTRACT

Operating a portable electronic device may include detecting a gesture performed above a capacitance sensing strip that is located between and arrangement of mechanical keys on keyboard assembly and the far side of the keyboard assembly, determining a number of fingers used in the gesture, selecting a mode based on the number of fingers, and executing an action in the selected mode.

### BACKGROUND

The present invention relates to computing devices such as laptops and desktops. These devices generally include a mechanical keyboard having an arrangement of keys where each key is connected to an electrical switch located under the key. When depressed, the switches cause the connection between different electrical lines which indicate which key has been depressed. Often computing devices will further include a touch pad that is integrated into the keyboard. The touch pad uses capacitance sensing to interpret commands that the user makes when touching the touchpad. The inputs from the keyboard and the touch pad can be used to operate the computing device. Often, the inputs from the keyboard and the touch pad allow a user to interact with images depicted in a display of the computing device. In some cases, the display is a touch sensitive display that uses touch inputs to allow the user to interact with the contents depicted in the screen. In other examples, the display is a non-touch sensitive display where inputs are received through the keyboard, the touch pad, or in some cases, audible commands.

An example of a computing device with both a touchpad and a keyboard is disclosed in U.S. Pat. No. 7,088,343 issued to Barton A. Smith, et al. This reference describes that a touchpad input device is provided that is disposed about at least a portion of at least one outside edge of an electronic device housing. The present invention also provides electronic devices comprising the present touchpad input device. Furthermore, the present invention provides a method of sensing user input about an outside edge of an electronic device housing, wherein the user input is detected by a user input detector that relays a signal to a control circuit to be acted upon appropriately.

U.S. Pat. No. 8,933,892 issued to Richard D. Woolley, describes a touch-sensitive and far-field or proximity sensitive touchpad combined with a display, wherein the touchpad is formed as a touch strip that is concealed inside the display, wherein a first function or interface such as a menu is enabled when an actuating device reaches a threshold distance from the touchpad, wherein a second function or interface is enabled when the actuating device makes contact with the touchpad, and wherein the first function may or may not continue after contact is made with the touchpad.

U.S. Pat. No. 10,114,485 issued to Gen-Hung Su, describes that a computer device includes a display and a base. The base includes a keyboard comprising a plurality of keys. The base further includes a first touchpad area at a first side of the keyboard, a second touchpad area at a second side of the keyboard, a third touchpad area at a third side of the keyboard and a fourth touchpad area at a fourth side of the keyboard. As there is a plurality of touchpad areas located at different sides of the keyboard, the user has more input options compared to the case if there was only one touchpad area located at one side of the keyboard. Each of these references is herein incorporated by reference for all that they disclose.

### SUMMARY

In one embodiment of the present disclosure, a portable electronic device includes a display assembly, a processor, memory in communication with the processor, a keyboard assembly, a connection mechanism connecting a connecting side the display assembly and to a far side the keyboard assembly where the display assembly is pivotally movable with respect to the keyboard assembly, the keyboard assembly including an arrangement of mechanical keys, and a capacitance sensing strip located between the arrangement of mechanical keys and the far side of the keyboard assembly. The capacitance sensing strip may include a first plurality of electrodes aligned in a first direction transverse a length of the capacitance sensing strip and generally spaced at a first interval and a second plurality of electrodes aligned in a second direction transverse a width of the capacitance sensing strip and generally spaced at a second interval that is shorter than the first interval. The memory including programmed instructions that, when executed, causes the processor to detect a gesture performed above the capacitance sensing strip, respond to the gesture in a first mode when the gesture is detected with a single finger, and respond to the gesture in a second mode when the gesture is detected with two fingers.

The first mode or the second mode may be a function keys mode where the programmed instructions cause the processor to execute an action based on a selection of a function key in response to detecting the gesture.

At least one icon of a function key may be depicted above the capacitance sensing strip.

The least one icon may be permanently marked on the keyboard assembly.

The least one icon may not be incorporated into a mechanical key and is not part of a virtual display.

The first mode or the second mode may be a slider mode where the programmed instructions cause the processor to adjust a parameter associated with the portable electronic device in response to a distance traveled by the gesture over the capacitance sensing strip.

The distance traveled may be in a direction transverse the length of the capacitance sensor strip.

The programmed instructions may be configured to cause the processor, when executed to respond to the gesture in a third mode when the gesture is detected with a predetermined number of fingers that is greater than two fingers.

The portable electronic device may include a touch pad incorporated into the keyboard assembly adjacent to the arrangement of mechanical keys.

The processor may include an integrated circuit that processes input from both the touch pad and the capacitance sensing strip.

Detecting the gesture with the two fingers may include that the two fingers are from a single hand and the two fingers are positioned together.

The first mode or the second mode may be an on-screen mode where programmed instructions cause the processor to interact with an object presented in the display assembly in response to detecting the gesture.

Detecting the gesture may include detecting the gesture moving in a direction transverse the length of the capacitance sensing strip.

In some embodiments, a method of controlling a portable electronic device may include detecting a gesture performed above a capacitance sensing strip that is located between and arrangement of mechanical keys on keyboard assembly and the far side of the keyboard assembly, determining a number of fingers used in the gesture, selecting a mode based on the number of fingers, and executing an action in the selected mode.

The selected mode may be a function keys mode and the action includes implementing a function of a selected function key icon in response to detecting the gesture over the selected function key icon.

At least one icon of a function key may be depicted above the capacitance sensing strip.

The least one icon may be permanently marked on the keyboard assembly.

The least one icon may not be incorporated into a mechanical key and is not part of a virtual display.

The selected mode may be a slider mode and the action includes adjusting a parameter associated with a selected parameter in response to a distance traveled by the gesture over the capacitance sensing strip.

The distance traveled may be in a direction transverse the length of the capacitance sensor strip.

Detecting the gesture may include detecting the gesture moving in a direction transverse the length of the capacitance sensing strip.

In some embodiments, a computer-program product for controlling a computing device may include a non-transitory computer-readable medium storing instructions executable by a processor to detecting a gesture performed above a capacitance sensing strip that is located between and arrangement of mechanical keys on keyboard assembly and the far side of the keyboard assembly, implementing a functions key mode when the detected gesture includes a single finger and selecting a function corresponding to a first selected icon of a first set of icons over which the gesture is performed, and implementing a slider mode when the detected gesture includes a two-finger gesture and adjusting a parameter corresponding to a second selected icon of a second set of icons over which the gesture is performed where the first set of icons are mutual exclusive to the second set of icons and the first set of icons and the second set of icons are located close enough together that the implementation of the function keys mode or the slider mode prevents a single gesture from triggering icons in both the first set and the second set.

In one embodiment, a method may include detecting a gesture performed above the capacitance sensing strip, responding to the gesture in a first mode when the gesture is detected with capacitance measurements having a single peak, and responding to the gesture in a second mode when the gesture is detected with the capacitance measurements having two peaks.

In one embodiment, a method may include detecting a gesture performed above the capacitance sensing strip, responding to the gesture in a first mode when the gesture is detected with capacitance measurements having a single peak above a predetermined threshold, and responding to the gesture in a second mode when the gesture is detected with the capacitance measurements having two peaks above the predetermined threshold.

In one embodiment, a method may include detecting a gesture performed above the capacitance sensing strip, responding to the gesture in a first mode when the gesture is detected with a total capacitance measurement being between a first predetermined threshold and a second predetermined threshold where the second predetermined threshold is higher than the first predetermined threshold, and responding to the gesture in a second mode when the gesture is detected with the total capacitance measurement being over the second predetermined threshold.

In one embodiment, a method may include detecting a gesture performed above the capacitance sensing strip, responding to the gesture in a first mode when the gesture is detected changing capacitance over a first area shaped like a single finger, and responding to the gesture in a second mode when the gesture is detected changing capacitance over a second area shaped like two fingers.

### BRIEF DESCRIPTION OF THE DRAWINGS

A further understanding of the nature and advantages of the present invention may be realized by reference to the following drawings. In the appended figures, similar components or features may have the same reference label.

FIG. 1 depicts an example of a computing device according to the present disclosure.

FIG. 2 depicts an example of a grid of a capacitance sensing strip according to the present disclosure.

FIG. 3 depicts an example of a keyboard device according to the present disclosure.

FIG. 4 depicts an example of a capacitance sensing strip in communication with logic of a processor according to the present disclosure.

FIG. 5 depicts an example of receiving instructions in a functions keys mode according to the present disclosure.

FIG. 6 depicts an example of adjusting a parameter in a slider mode according to the present disclosure.

FIG. 7 depicts an example of adjusting a parameter in a slider mode according to the present disclosure.

FIG. 8 depicts an example of receiving an instruction in an on-screen mode according to the present disclosure.

FIG. 9 depicts an example of interacting with an object in a screen according to the present disclosure.

FIG. 10 depicts an example of an area of capacitance measurements shaped like two fingers according to the present disclosure.

FIG. 11 depicts an example of multiple predetermined capacitance threshold values according to the present disclosure.

FIG. 12 depicts an example of multiple peaks in capacitance measurements according to the present disclosure.

FIG. 13 depicts an example of multiple peaks above a predetermined threshold in capacitance measurements according to the present disclosure.

FIG. 14 depicts an example of a strip module according to the present disclosure.

FIG. 15 depicts an example of a method of using a capacitance sensing strip according to the present disclosure.

FIG. 16 depicts an example of a method of using a capacitance sensing strip according to the present disclosure.

FIG. 17 depicts an example of a method of using a capacitance sensing strip according to the present disclosure.

### DETAILED DESCRIPTION OF THE INVENTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

For purposes of this disclosure, the term “aligned” generally refers to being parallel, substantially parallel, or forming an angle of less than 35.0 degrees. For purposes of this disclosure, the term “transverse” generally refers to perpendicular, substantially perpendicular, or forming an angle between 55.0 and 125.0 degrees. For purposes of this disclosure, the term “length” generally refers to the longest dimension of an object. For purposes of this disclosure, the term “width” generally refers to the dimension of an object from side to side and may refer to measuring across an object perpendicular to the object's length.

For purposes of this disclosure, the term “electrode” generally refers to a portion of an electrical conductor intended to be used to make a measurement, and the terms “route” and “trace” generally refer to portions of an electrical conductor that are not intended to make a measurement. For purposes of this disclosure in reference to circuits, the term “line” generally refers to the combination of an electrode and a “route” or “trace” portions of the electrical conductor. For purposes of this disclosure, the term “Tx” generally refers to a transmit line, and the term “Rx” generally refers to a sense line.

For the purposes of this disclosure, the term “computing device” generally refers to electronic devices that include processors. Examples may include a laptop, a desktop, a flip phone, electronic tablet, other devices, or combinations thereof.

For purposes of this disclosure, the term “connecting side of a display” generally refers to the side of the display that is connected to the keyboard. In some instances, the connecting side of the display includes or is connected to a hinge joint, a pivot joint, or another type of joint that connects the keyboard and the display, but allows relative movement between them. For example, in an instance where the bottom edge of the display includes at least one arm that extends and connects to a pivot that forms at least a portion of the connection mechanism between the display and the keyboard, the bottom side of the display may be considered to be the connecting side of the display.

For purposes of this disclosure, the term “far side of the keyboard” generally refers to the side of the keyboard that is farthest away from the user when the user is operating the computing device as the computing device is intended to be used. For example, a user may place the computing device on a table surface with the display oriented to be between 35 and 60 degrees with respect to the keyboard. Further, the display side of the display assembly may be facing the user when the user is operating the laptop. In this example, the keyboard may be positioned between the user and the display. The keyboard may be oriented so that a “proximate side” of the keyboard is the side closest to the user when the user is operating the laptop. The proximate side of the keyboard may be opposite to the far side of the keyboard. In some instances, the touch pad is located on the proximate side of the keyboard, the capacitance sensing strip is located on far side of the keyboard, and the arrangement of mechanical keys is located between the touch pad and the capacitance sensing strip. In some examples, the far side of the keyboard may also be connected to the connecting side of the display.

For the purposes of this disclosure, the term “mechanical key” generally refers to a movable key that has a top surface that is independent of the working surface of the keyboard. When a mechanical key is depressed, the physical movement of the key causes the two electrical circuits to electrically connect underneath the mechanical key. Electrically connecting the electrical circuits may be facilitated by the movement of the mechanical key triggering a switch which completes the process of temporarily electrically connecting the two circuits. Voltage changes can be sensed in at least one of the electrical circuits, which allows the identification of which electrical circuits came into contact. Knowing which electrical circuits came into contact allows for a determination of which key was pressed. Any appropriate type of switch may be used in accordance with the principles described in the present disclosure. A non-exhaustive list of switches that may be used in accordance with the present disclosure include, but are not limited to, dome switches, membrane switches, mechanical switches, galvanic switches, other types of switches, or combinations thereof.

In contrast to mechanical keys, virtual keys are depicted to the user but require no physically moving parts. Virtual keys may include capacitive or resistive applications to detect when a virtual key is selected. For example, a touch sensitive screen may depict an image that appears as a key, such as an alphanumeric symbol, an icon, or another type of image. Often, underneath or behind a virtual key is a capacitance sensor which detects when an electrically conductive object, like a finger, stylus, or another type of object is approaching. Based on the change of capacitance resulting from the proximity of the finger to the capacitance sensor, it may be determined that the user intends to select the virtual button. In such capacitance examples, the virtual button does not include a mechanical switch, and/or a depression of the key. In some cases, a resistive button may involve the user pressing hard enough on the surface such that the surface flexes with the implied force. Such flexing may cause electrical circuits located at different levels to electrically connect. However, in this example of a virtual key, no mechanical switch is used. Further, in this example of a virtual key, no key moves independently of the surface of the keyboard, rather, the keyboard's surface flexes.

It should be understood that use of the terms “touch pad” and “touch sensor” throughout this document may be used interchangeably with “capacitive touch sensor,” “capacitive sensor,” “capacitive touch and proximity sensor,” “proximity sensor,” “touch and proximity sensor,” “touch panel,” “touchpad,” and “touch screen.” Further, for the purposes of this disclosure, the term “proximity controller” or “touch controller” is a logic device capable of receiving electrical measurements to determine changes in capacitance to determine whether an object is in proximity to a key position or another location. In some cases, the proximity controller may determine a distance the object is away from the key position or another location.

For the purposes of this disclosure, the term “capacitance sensing strip” may generally refer to a capacitance sensor. In some examples, the capacitance sensing strip may have a longer length than width. The capacitance sensing strip may include a grid of electrodes with a first set of electrodes aligned with a length of the strip and a second set of electrodes aligned with a width of the strip.

For the purposes of this disclosure, the term “gesture” may generally refer to a hand gesture. In some cases, the gestures may involve touching a virtual key, an icon, or other symbol. In some cases, while touching such surfaces is involved in the gesture, the touching may not be required to make the desired instructions through the gesture. Further, in some cases, the gesture may involve movements that are above the surface without touching. Gestures may include tapping movements, sliding movements, swiping movements, pinching movements, expanding movements, hovering movements, two-dimensional movements, three-dimensional movements, complex movements, single movements, a series of sequential movements, other types of movement, or combinations thereof.

For the purposes of this disclosure, the term “mode” may generally refer to a user interface mode. When the computing device operates in different modes, the same or similar inputs may trigger different responses. For example, a specific command of a first mode may trigger a first type of response while the same specific command of a set mode may trigger a second type of response that is different than the first response.

For the purposes of this disclosure, the term “function keys” may generally refer to a set of programmed functions associated with icons depicted between the far edge of the keyboard and the arrangement of keys. These functions may include shortcuts, saving files, printing data, refreshing pages, other functions, or combinations thereof. For example, the F1 key is conventionally used as a default help key, and the F5 key may be used to refresh a web page.

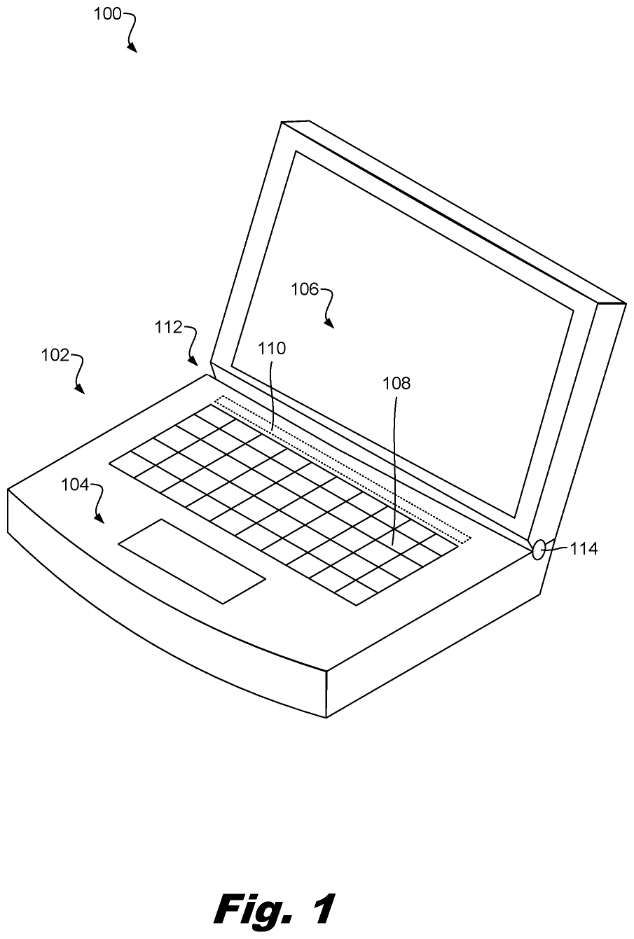

FIG. 1 depicts an example of a computing device 100. In this example, the computing device is a laptop. In the illustrated example, the computing device 100 includes an input device, such as a keyboard 102 and a touch pad 104. The computing device 100 also includes a display 106. A program operated by the computing device 100 may be depicted in the display 106 and controlled by a sequence of instructions that are provided by the user through the keyboard 102 and/or through the touch pad 104.

The keyboard 102 includes an arrangement of keys 108 that can be individually selected when a user presses on a key with a sufficient force to cause the key 108 to be depressed towards a switch located underneath the keyboard 102. In response to selecting a key 108, a program may receive instructions on how to operate, such as a word processing program determining which types of words to process. A user may use the touch pad 104 to add different types of instructions to the programs operating on the computing device 100. For example, a cursor depicted in the display 106 may be controlled through the touch pad 104. A user may control the location of the cursor by sliding his or her hand along the surface of the touch pad 104. In some cases, the user may move the cursor to be located at or near an object in the computing device's display and give a command through the touch pad 104 to select that object. For example, the user may provide instructions to select the object by tapping the surface of the touch pad 104 one or more times.

The touch pad 104 may include a capacitance sensor disposed underneath a surface of the keyboard 102. In some examples, the touchpad 102 is located in an area of the keyboard's surface where the user's palms may rest while typing. The capacitance sensor may include a printed circuit board that includes a first layer of electrodes oriented in a first direction and a second layer of electrodes oriented in a second direction that is transverse the first direction. These layers may be spaced apart and/or electrically isolated from each other so that the electrodes on the different layers do not electrically short to each other. Capacitance may be measured at the overlapping intersections between the electrodes on the different layers. However, as the user's finger or other electrically conductive objects approach the intersections, the capacitance may change. These capacitance changes and their associated locations may be quantified to determine where the user is touching or hovering his or her finger within the area of the touchpad 104. In some examples, the first set of electrodes and the second set of electrodes are equidistantly spaced with respect to each other. Thus, in these examples, the sensitivity of the touchpad 104 is the same in both directions.

In addition to the touchpad 104, the keyboard 102 may also include a capacitance sensing strip 110. In this example, the capacitance sensing strip 110 is located between the arrangement of keys and the far side 112 of the keyboard 102. The capacitance sensing strip 110 may be a capacitance sensor located underneath a surface of the keyboard 102. In this example, the area of the keyboard 102 above the capacitance sensing strip 110 is free of mechanical keys. Icons, symbols, or other types of images may be disposed in the area above the capacitance sensing strip 110. The capacitance sensing strip 110 may include a grid of electrodes that can interpret instructions from the user. In some cases, the hardware associated with the capacitance sensing strip 110 interprets instructions the same way or similarly to how hardware associated with the touchpad interprets instructions from the user. In some cases, the touchpad 104 and the capacitance touching strip 110 may share the same hardware. In some examples, the capacitance sensing strip 110 may be configured to use instructions from the user differently than how the touchpad 104 is configured to interpret instructions.

The touchpad 104 and the capacitance sensing strip 110 may have the same or a similar degree of sensitivity as each other. However, in other examples, the capacitance sensing strip 110 may be more sensitive than the touchpad in certain parameters or vice versa. For example, the capacitance fields of the touchpad 104 may be sensitive enough to detect touch inputs from the user, while the capacitance fields of the capacitance sensing strip 110 may be projected farther away to detect touch and proximity inputs from the user. In other examples, the capacitance sensing strip 110 may include a denser arrangement of electrodes that are aligned with the length of the capacitance sensing strip than along it's width. In this particular example, a user's finger may cross over more electrodes as the user moves his or her finger across the strip's width for five millimeters than the finger would cross is the finger were moved along the strip's length rather than width. This increased number of inputs may cause the capacitance sensing strip 110 to be more sensitive in directions aligned with its width than aligned with its length.

The location of the capacitance sensing strip 110 may allow the user to interact with objects in the display in a convenient manner. For example, a menu of icons may be depicted at bottom of the display, and the location of the capacitance sensing strip 110 may allow the user to interact with these menu items without having to move his or her hand away from the arrangement of keys towards a mouse or trackpad. Rather, in such an example, the user may keep his or her hands over the arrangement of keys and extend one or more fingers over the area above the capacitance sensing strip 110 to give instructions on how to interact with the menu items.

In the example depicted in FIG. 1, the capacitance sensing strip 110 is located in the area conventionally occupied with function keys. In some examples, icons may be placed in the area of the keyboard 102 above the capacitance sensing strip 110 that depict symbols associated with the function keys. Further, the capacitance sensing strip 110 may distinguish between situations when the user desires to interact with an object on the screen and when the user desires to give a command to operate a function key based on the number of fingers that the user provides when making a gesture input. For example, the capacitance sensing strip 110 may interpret commands that use a single finger as a command to operate a function key while commands with two or more fingers may be interpreted to interact with the objects on the screen. In this example, the user may instruct the computing device which mode that the capacitance sensing strip is to operate in by the number of fingers used in the input. Examples of modes under which the capacitance sensing strip may operate include a functions key mode, a slider mode, an on-screen mode, another type of mode, or combinations thereof.

In some cases, the display 106 is mechanically separate and movable with respect to the keyboard with a connection mechanism 114. In these examples, the display 106 and keyboard 102 may be connected and movable with respect to one another. The display 106 may be movable within a range of 0 degrees to 180 degrees with respect to the keyboard 102. In some examples, the display 106 may fold over onto the upper surface of the keyboard 102 when in a closed position, and the display 106 may be folded away from the keyboard 102 when the display 106 is in an operating position. In some examples, the display 160 may be orientable with respect to the keyboard 102 at an angle between 35 to 60 degrees when in use by the user. However, in these examples, the display 106 may be positionable at an angle desired by the user.

In some examples, the display 106 may be a non-touch sensitive display. In such an example, gestures used over the capacitance sensing strip may not unintentionally cause false positive readings in capacitance sensors that would otherwise be interpreted as instruction to a touch sensitive display. This may be especially true when the display is oriented at an angle that brings the capacitance sensing strip and the bottom portion of the display 106 in close proximity to each other.

However, in other examples at least a portion of the display 106 is touch sensitive. In these examples, the touch sensitive display may include a capacitance sensor that is located behind an outside surface of the display 106. As a user's finger or other electrically conductive object approaches the touch sensitive screen, the capacitance sensor may detect a change in capacitance as an input from the user.

FIG. 2 depicts an example of a capacitance sensing strip 200. In this example, the capacitance sensing strip 200 may include a substrate 202, first set 204 of electrodes, and a second set 206 of electrodes. The first and second set 204, 206 of electrodes may be oriented to be transverse to each other. Further, the first and second set 204, 206 of electrodes may be electrically isolated from one another so that the electrodes do not short to each other. However, where electrodes from the first set 204 overlap with electrodes from the second set 206, capacitance can be measured. In contrast to some narrow capacitance sensors, for the purposes of this disclosure, the capacitance sensing strip includes more than one electrode in both sets. Often, a capacitance sensor, such as a sensor in a conventional touch pad, the electrodes of both sets are equidistantly spaced in both directions. However, for the purposes of this disclosure, the capacitance sensing strip 200 includes electrodes that are spaced closer when aligned with the length of the strip rather than along the width of the strip. By positioning the electrodes that are aligned with the length of the strip 200, a greater sensitivity to gestures moving across the width of the capacitance sensing strip 200 may be achieved. For example, when a user moves his or her finger across the width of the capacitance sensing strip 200, the movement of the finger can be detected. In some cases where there is only one electrode aligned with the length of the strip 200, a position along the width of the capacitance sensing strip 200 cannot be distinguished. In such an example, only those gestures that move along the length of the capacitance sensing strip 200 can be distinguished from one another. Further, in this example, for a movement to be detected along the length of the capacitance sensing strip, the gesture may have to move a predetermined distance. However, in such an example, gestures that move less than the predetermined distance along the width of the capacitance sensing strip may be detected.

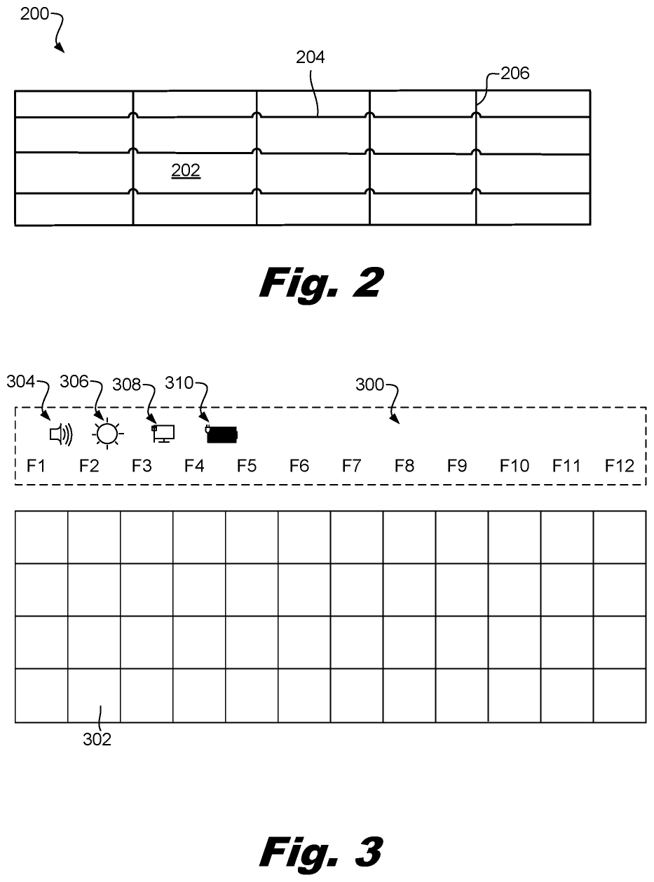

FIG. 3 depicts a closer view of the area above the capacitance sensing strip 300 and the arrangement of keys 302. In this example, the symbols of F1, F2, F3, etc. may be permanently depicted on the keyboard and represent virtual keys. An additional audio virtual key 304, a brightness virtual key 306, a network virtual key 308, and a power virtual key 310 are also depicted in this example. These keys 304, 306, 308, 310 may be triggered in a different mode than the function keys. For example, triggering the use of the functions keys may involve detecting a one-finger gesture, while triggering the other keys 304, 306, 308, 310 may involve two-finger gestures. At least some of the keys may trigger functions that involve adjusting parameters. For example, the audio key, when triggered, may cause a slider to appear that represents the current volume of the computer device's audio system. To change the volume, the user may slide his or her hand along the length of the slider in the direction desired to adjust the volume. The slider may appear in the area above the capacitance sensing strip, in the display, another location, or combinations thereof.

The virtual keys may be depicted permanently on the keyboard. In some examples, a permanently depicted virtual key may be less noticeable when the virtual key is not illuminated. For example, the symbols of the virtual keys may be formed out of a transparent or semi-transparent material. When a backlight behind the virtual key is illuminated, the virtual key may be noticeable. However, when the backlight is turned off, the permanent virtual key may be less noticeable. In other examples, a display is located in the area above the capacitance sensing strip 300. In this example, the display can depict a subset of the virtual keys based on the mode that the computing device is operating. For example, when a user provides a one-finger gesture, the virtual keys of the mode associated with the one-finger gesture may be depicted in the keyboard display. Likewise, when a user provides a two-finger gesture, the virtual keys of the mode associated with the two-finger gesture may be depicted in the keyboard display, and so forth with three-finger gestures, four-finger gesture, and five-finger gestures.

In some examples in the area above the capacitance sensing strip 300, no mechanical keys may be present. Thus, to trigger the function of the function keys or the other functions associated with the other depictions in the example of FIG. 3, the user may have to provide an input that can be detected through capacitance sensing.

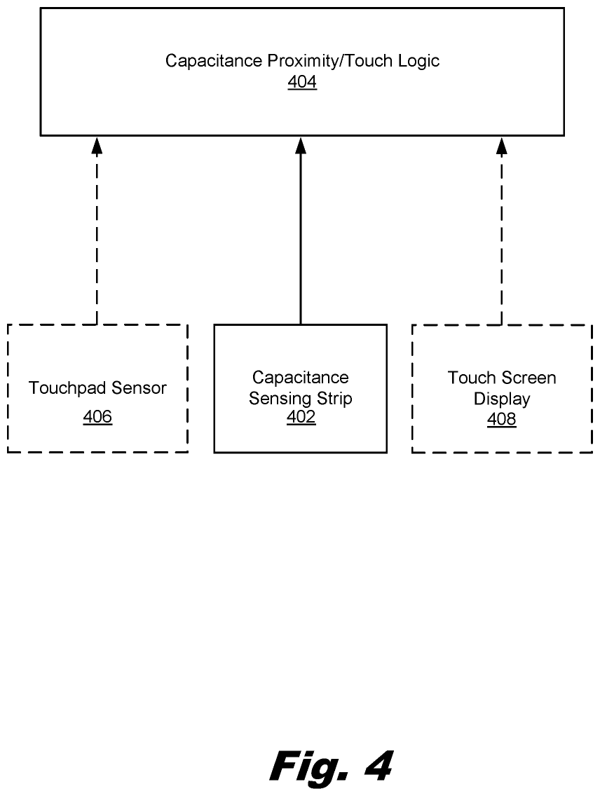

FIG. 4 depicts an example of components of a computing device. In this example, the capacitance sensing strip 402 is in communication with a capacitance logic 404 for detecting touch and/proximity inputs. Optionally, in some cases, a touchpad sensor 406 and/or a touch screen display 408 may be in communication with the same capacitance logic 404.

In some examples where a touch screen display is incorporated into the computing device, separate logic may be used to interpret the inputs from the touch screen display rather than using the same logic used to interpret commands from the capacitance sensing strip. Likewise, in some examples where a touchpad sensor is incorporated into the computing device, separate logic may be used to interpret the inputs from the touchpad sensor rather than using the same logic used to interpret commands from the capacitance sensing strip.

In some cases, the capacitance logic 404 is incorporated into an integrated circuit located on the motherboard of the computing device. An advantage to the principles described in the present disclosure is that real estate on the motherboard may be minimized by having a single integrated circuit 212 on the motherboard 302 that handles the processing of all capacitance inputs rather than having a separate integrated circuit for each of the capacitance input sources (e.g. touchpad sensor, capacitance sensing strip, and a touch screen) integrated into the computing device.

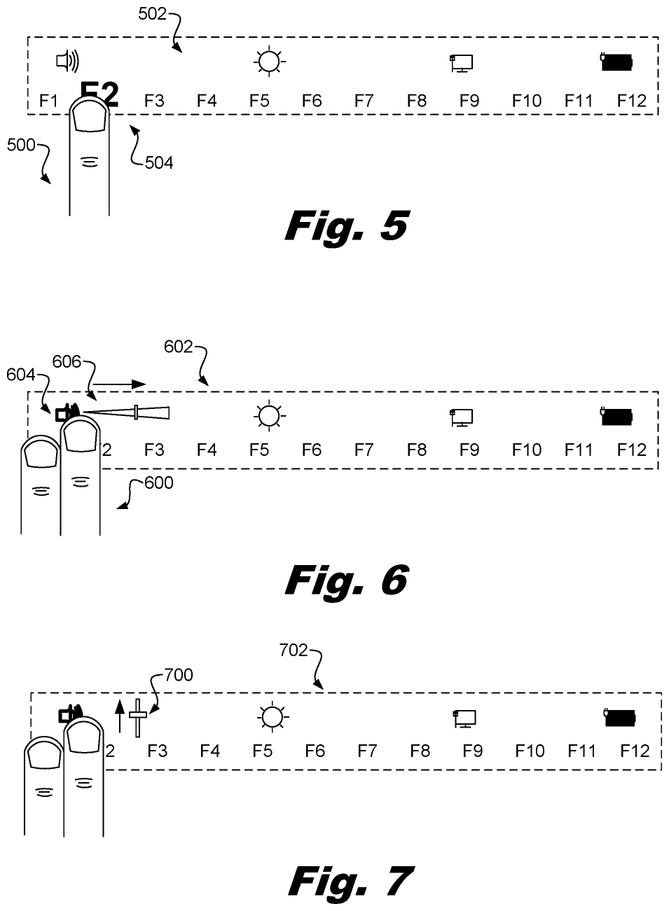

FIG. 5 depicts an example where a one-finger gesture 500 is performed over a capacitance sensing strip 502 in accordance with the principles described herein. In this example, the one-finger gesture 500 triggers a function keys mode. In the function keys mode, the programmed instructions associated with the capacitance sensing strip 502 may interpret inputs from the user to be for selecting one of the function keys depicted on in the area above the capacitance sensing strip 502. As depicted in FIG. 5, the finger is hovering over the F2 virtual key 504. As a result, the programmed instructions associated with the capacitance sensing strip 502 may determine that the user intends to select the F2 function.

In some examples, the F2 virtual key may include a permanent icon. In other examples, the F2 icon may be removable. In yet other examples, the area above the capacitance sensing strip 502 may be a display with pixels where the symbol F2 is depicted, but may be replaced with other images. In yet another example, the F2 icon may be made of a transparent or semitransparent material so that the F2 icon may be illuminated with a back light.

In some cases, the programmed instructions associated with the capacitance sensing strip 502 may sense that the one-finger gesture is over another icon that is not associated with the function keys. In those examples where the function keys mode is triggered by one-finger gestures, the programmed instructions may determine that when the one-finger gesture is over a virtual key that is not one of the function keys, that no response is to be taken by the computing device. However, in some cases, the one-finger gesture may hover partial over a function key and another virtual key that is not a function key when in the function keys mode. In this example, the system may select the function key due to the operating mode. In other examples, a virtual key may be activated in both a first mode and a second mode, but the function is different depending on the mode. For example, the F2 button may provide an F2 function in the function keys mode and an audio mode in the slider mode. While this example has been described with reference to the one-finger gestures triggering a functions keys mode, the one-finger gestures may trigger any appropriate type of mode. For example, a non-exhaustive list of modes that may be triggered by a one-finger gesture includes a function keys mode, a slider mode, an on-screen mode, another type of mode, or combinations thereof.

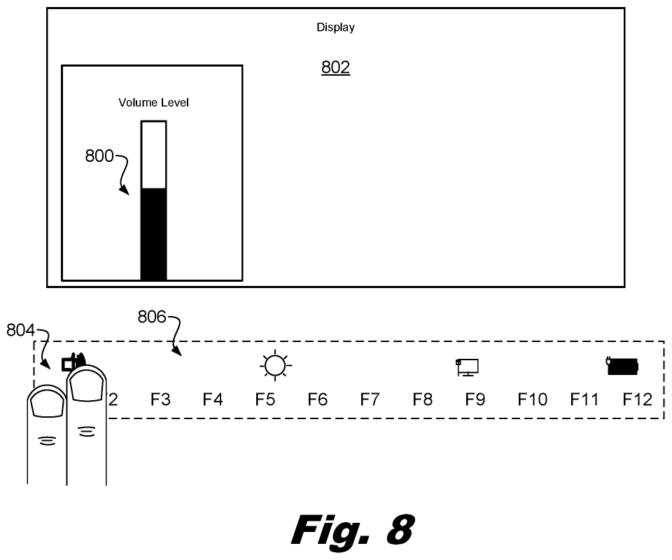

FIG. 6 depicts an example where a two-finger gesture 600 is performed over a capacitance sensing strip 602 in accordance with the principles described herein. In this example, the two-finger gesture 600 triggers a slider mode. In the slider mode, the programmed instructions associated with the capacitance sensing strip 602 may interpret inputs from the user to be for selecting one of the adjustable parameters depicted in the area above the capacitance sensing strip 602. As depicted in FIG. 6, the fingers are hovering over the audio virtual key 604. As a result, the programmed instructions associated with the capacitance sensing strip 602 may determine that the user intends to adjust the volume of the audio system.

In this example, when the two-finger gesture 600 hovers over the audio virtual key, a slider 606 may appear in the area above the capacitance sensing strip 602, the display, or another location. In some cases, the user may seamlessly move his or her fingers along the length of the slider to adjust the audio's parameter up or down. In some cases, the user may trigger the slider mode with the two-finger gesture, and then user a different command to adjust the parameter. For example, the user may instruct the computing device to display the audio slider by selecting the audio virtual key 604 with the two-finger gesture, and then use a one-finger gesture or another type of gesture to adjust the parameter.

In some cases, the user may adjust the parameter by moving a gesture along the length of the slider in either direction. In some cases, the user may cause the slider mode to turn off or trigger another action by moving the gesture in a direction that is transverse the length of the slider. In some cases, the user may trigger a menu when triggering the slider mode with the appropriate gesture and the user may move the gesture in a direction that is transverse the direction of the slider to view more menu items.

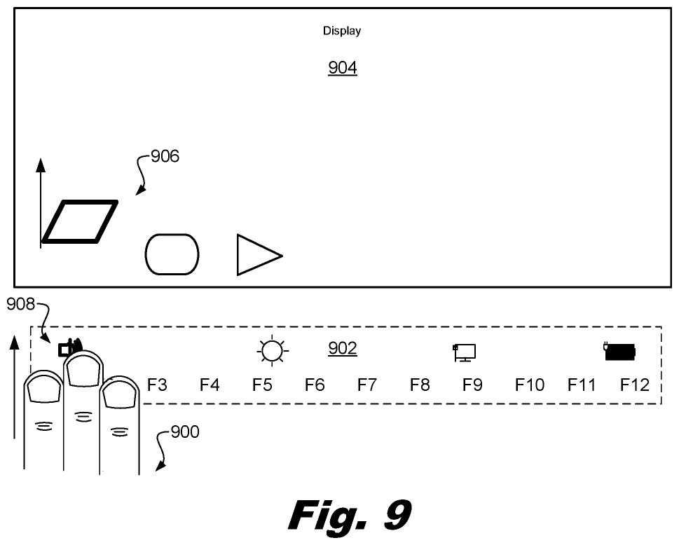

In the example depicted in FIG. 6, the slider's length is aligned with the length of the capacitance sensing strip 602. In some examples, the slider 700 may be depicted in a direction that is transverse the direction of the length of the capacitance sensing strip 702 as depicted in FIG. 7. In the example of FIG. 8, the slider 800 is depicted in the display 802. In this example, as the user moves his or her gesture 804 in a direction transverse to the length of the capacitance sensing strip 806, the parameter of the slider 800 is adjusted.

While the examples of FIGS. 6-8 have been described with relation to a two-finger gesture triggering a slider mode, the two-finger gesture may trigger any appropriate type of mode.

FIG. 9 depicts an example where a three-finger gesture 900 is performed over a capacitance sensing strip 902 in accordance with the principles described herein. In this example, the three-finger gesture 900 triggers an on-screen mode. In the on-screen mode, the programmed instructions associated with the capacitance sensing strip 902 may interpret inputs from the user to be for selecting and/or interacting with objects depicted in the display 904. As depicted in FIG. 4, the fingers are positioned adjacent to a first object 906 in the display 904. As a result, the programmed instructions may determine that the user intends to select the first object 906.

In some examples, the user may interact with the object by selecting the object, opening a program associated with the object, move the object on the screen, rotate the object, change the size of the object, open a menu associated with the object, trigger a function associated with the object, execute a task associated with the object, or combinations thereof.

In the example of FIG. 9, the three-finger gesture is hovering over the audio virtual key 908, the F1 virtual key (not shown), and the F2 virtual key (not shown). In this example, the functional key mode and the slider mode are not triggered, so the functions relating to these virtual keys are not triggered. However, in other examples, a three-finger gesture may trigger at least one of these virtual keys, a different function in at least one of these keys, trigger another type of response associated with at least one of these keys, or combinations thereof. While the example of FIG. 9 has been described with relation to a three-finger gesture triggering an on-screen mode, the three-finger gesture may trigger any appropriate type of mode.

While the gestures have been described with reference to specific movements (e.g. hovering, moving aligned with a length of the capacitance sensing strip, moving transverse a width) above the capacitance sensing strip, any appropriate type of hand gesture may be detectable over the keyboard. The hand gesture may be recognized through a motion over the capacitance sensing strip based, at least in part, on movement along a direction aligned with the length of the capacitance sensing strip, a direction aligned with the width of the capacitance sensing strip, a vertical direction in relation to the capacitance sensing strip, a direction diagonal to the capacitance sensing strip, another direction, another type of movement, or combinations thereof. In some cases, the hand gesture may include a U-shaped movement, a circular movement, an angled movement, an L-shaped movement, a spiral movement, a diagonal movement, a vertical movement, a lateral movement, zig zagged movement, a continuous movement, a tapping movement, a waving movement, a discontinuous movement, a pinching movement, an asymmetric movement, a clapping movement, another type of movement, or combinations thereof.

In some cases, the gesture is detectable when the gesture is performed close to the keys of the capacitance sensing strip. In other examples, the gesture may be detectable when the gesture is positioned within a three dimensional space defined by the length of the capacitance sensing strip, the width of the capacitance sensing strip, and the height of the computing device's display.

FIG. 10 depicts an example of analyzing data to determine the number of fingers in a gesture. In this example, the measurements gathered from the capacitance sensing strip may be organized into a bit mask that represents the area 1000 associated with the capacitance sensing strip. Each square may represent the average capacitance in the area corresponding to the location on the capacitance sensing strip. In this example, each black square 1002 represents an average capacitance measurement above a predetermined value, while white squares 1004 represent areas that have an average capacitance value less than the predetermined value. The bit mask may be used to analyze the collective shapes of the squares representing the higher capacitance value to determine the number of fingers in the gesture. In some examples, if the area of squares representing the higher capacitance values is shaped like a single finger, then the system may determine that the user is using a one-finger gesture. In some examples, if the shape formed resembles two fingers, then the system may determine that the gesture is a two-finger gesture, and so on. In this example, the collective shape of the bit mask resembles two fingers, and the system may determine that the gesture is a two-finger gesture.

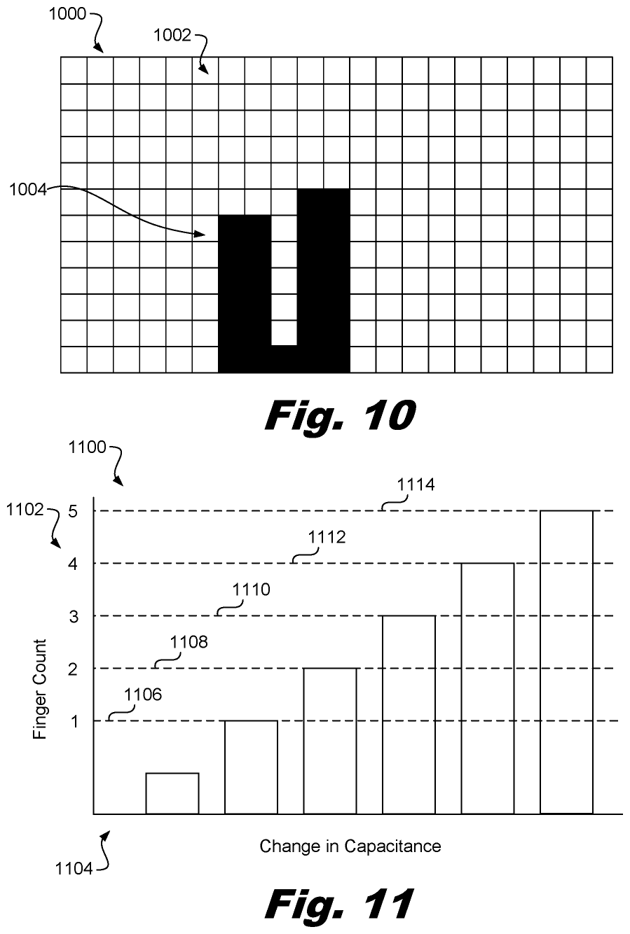

FIG. 11 depicts an example of analyzing data to determine the number of fingers in a gesture. In this example, a chart 1100 has a y-axis 1102 representing a finger count and an x-axis 1104 representing a change in capacitance. A first dotted line 1106 represents a first predetermined threshold representing the amount of capacitance associated with a one-finger gesture, a second dotted line 1108 represents a second predetermined threshold representing the amount of capacitance associated with a two-finger gesture, a third dotted line 1110 represents a third predetermined threshold representing the amount of capacitance associated with a three-finger gesture, a fourth dotted line 1112 represents a fourth predetermined threshold representing the amount of capacitance associated with a four-finger gesture, and a fifth dotted line 1114 represents a fifth predetermined threshold representing the amount of capacitance associated with a five-finger gesture. In this example, if the capacitance measurement is above the first predetermined threshold and below the second predetermined threshold, the system may determine that the gesture is a one-finger gesture. Likewise, if the capacitance measurement is above the second predetermined threshold and below the third predetermined threshold, the system may determine that the gesture is a two-finger gesture, and so on.

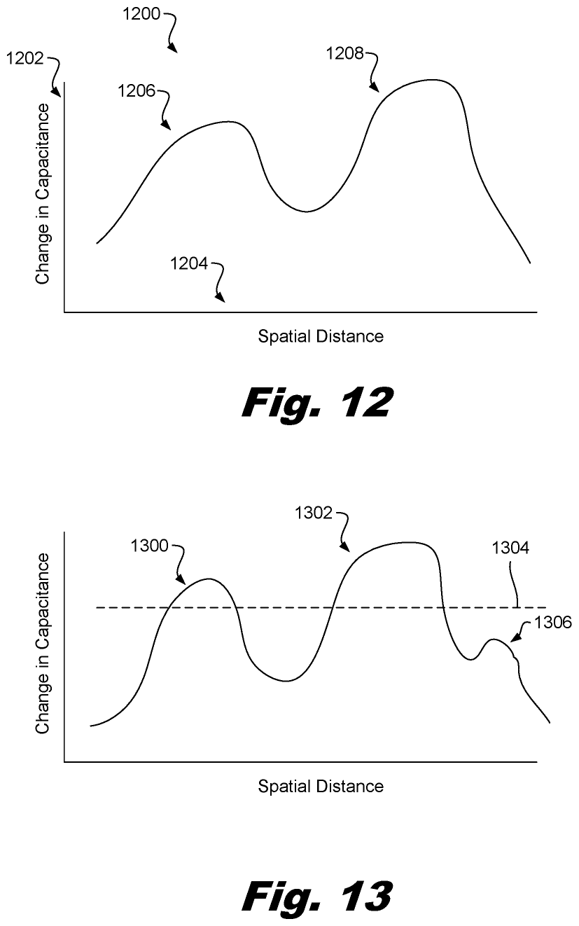

FIG. 12 depicts an example of analyzing data to determine the number of fingers in a gesture. In this example, a chart 1200 has a y-axis 1202 representing a change in capacitance and an x-axis 1204 representing a spatial distance that correlates the positions above the capacitance sensing strip. In this example, the peaks may have positive slopes within predetermined angles and/or ranges approaching the peaks that may assist in distinguishing between peaks that correspond with fingers and peaks that are more likely to correspond with noise. The system analyzing the data may determine that each peak meeting the appropriate criteria represents a finger. In the example depicted in FIG. 12, a first peak 1206 and a second peak 1208 are depicted. In such an example, the system may determine that the gesture includes two fingers, which correspond to each of the peaks. In some examples, the angle, shape, or other characteristic associated with the slope approaching the peaks may be used to determine the number of fingers. For example, if two positive slopes with the appropriate angle and length are detected in the graph, then the system may determine that there are two fingers.

FIG. 13 depicts an example where each of the peaks must cross a predetermined capacitance threshold before the system determines that the peak correlates with a finger. The peaks may be separated by a space with a lower capacitance value that drops below the predetermined capacitance threshold. In the illustrated example, a first peak 1300 and a second peak 1302 each cross a predetermined capacitance threshold represented by a dotted line 1304. A third peak 1306 does not cross the predetermined capacitance threshold, and may be determined to not be a finger in this example.

While the examples in FIGS. 10-13 depict specific embodiments for detecting a number of fingers in a gesture, any appropriate analysis for determining the finger count may be used. Further, while the specific examples above detect two fingers in some instances, the analysis described above may be used to detect a single finger, two fingers, three fingers, four fingers, five fingers, another number of fingers, or combinations thereof.

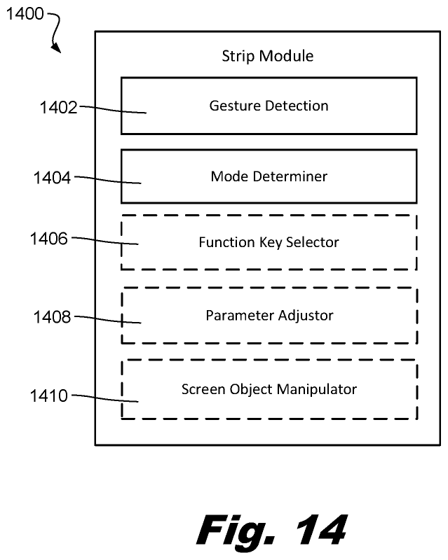

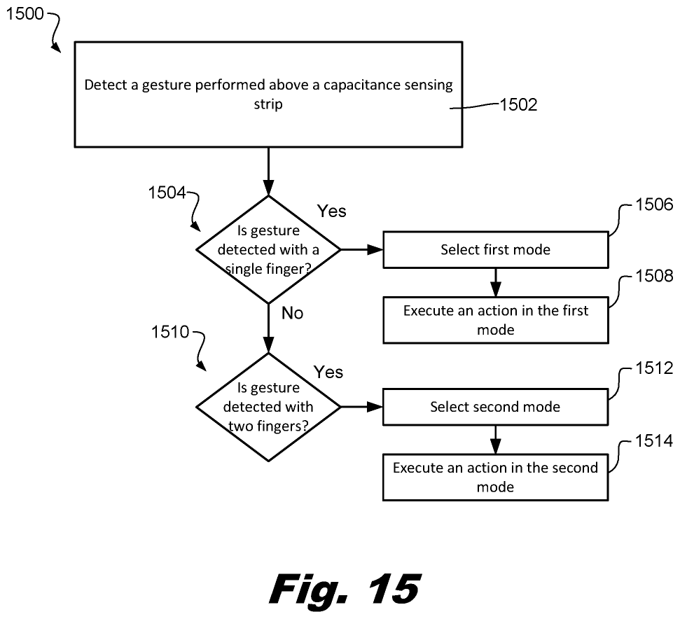

FIG. 14 depicts an example of a strip module 1400. In this example, the strip module 1400 includes programmed instructions in memory and may include associated firmware, logic, processing resources, memory resources, power sources, processing resources, hardware, or other types of hardware to carry out the tasks of the strip module 1400. The strip module 1400 includes a gesture detection 1402 and a mode determiner 1404. Optionally, the strip module 1400 may include a function key selector 1406, a parameter adjustor 1408, and/or a screen object manipulator 1410.

The gesture detection module 1402 may determine if a gesture is being made, and if so, the type of gesture being made. For example, the gesture detection module may determine that a gesture is being made if the capacitance over a region of the capacitance sensing strip increases. In some examples, the increased capacitance may trigger an analysis of the capacitance values to determine the number of fingers associated with the gesture. Any appropriate method for determining the number of fingers in the gesture may be used, including, but limited to, the analyses described in conjunction with FIGS. 10-13. In some examples, further analyses may determine other characteristics about the gesture, which may include, but are not limited to, determining an elevation at which the gesture is being made, a direction that the gesture is moving, a pattern of movement made with the gesture, the duration of time the gesture is being made, another characteristic, or combinations thereof.

The mode determiner 1404 may determine the mode for the computing device to execute based on at least one characteristic of the gesture. In some examples, the mode is determined based on the number of fingers in the gesture. In some examples, a predetermined, number of fingers may trigger a function keys mode, a parameter adjustment mode, an on-screen mode, another type of mode, or combinations thereof.

The function key selector 1406 may be activated when the appropriate mode is triggered. In some examples, the function key selector 1406 determines which virtual function key is being selected by the user based on an analysis of capacitance input from the capacitance sensing strip. In those situations where a virtual function key is selected, the function key selector 1406 may cause the function of the function key to be executed.

The parameter adjustor 1408 may be activated when the appropriate mode is triggered. In this example, the parameter adjustor 1408 may determine which parameter to present to the user. In some cases, when the parameter adjustor 1408 presents a parameter to be adjusted, the parameter adjustor 1408 presents a slider or another mechanism that the user can interact with to change the parameter's setting. For example, if the audio parameter is selected, the parameter adjustor 1408 may present an audio slider that allows the user to indicate which direction to adjust the volume of the audio. In some cases, multiple sliders may be presented allowing the user to modify the volume, frequency, amplitude, base, balance, other audio parameters, or combinations thereof.

The screen manipulator 1410 may be activated when the appropriate mode is triggered. In this example, the screen manipulator may analyze capacitance data from the capacitance sensing strip to determine if a user is selecting an object on the screen, moving an object on the screen, opening a program associated with an object on the screen, changing a characteristic (e.g. color, brightness, size, shape, etc.) of the object, executing other interactions with the object, or combinations thereof.

FIG. 15 depicts an example of a method 1500 of using a capacitance sensing strip according to the present disclosure. This method 1500 may be performed based on the description of the devices, module, and principles described in relation to FIGS. 1-14. In this example, the method 1500 includes detecting 1502 a gesture performed above a capacitance sensing strip and determining 1504 if the gesture is detected with a single finger. If the gesture is detected with a single finger, then the method includes selecting 1506 a first mode and executing 1508 an action in the first mode. If the gesture does not have a single finger, then the method 1500 includes determining 1510 whether the gesture is detected with two fingers. If the method is determined with two fingers, then the method 1500 includes selecting 1512 a second mode and executing 1514 an action in the second mode.

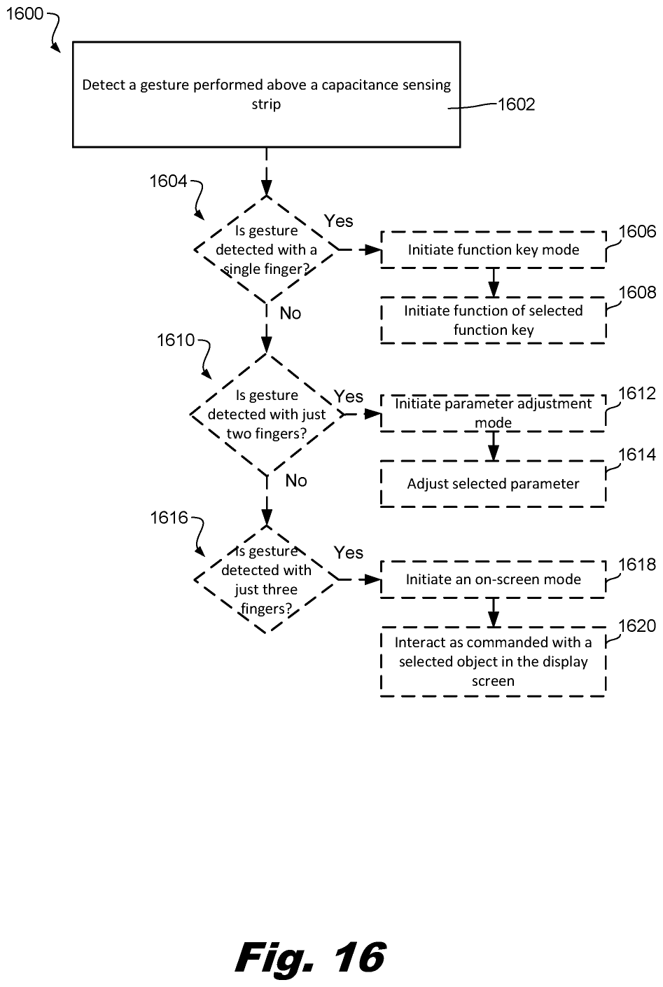

FIG. 16 depicts an example of a method 1600 of using a capacitance sensing strip according to the present disclosure. This method 1600 may be performed based on the description of the devices, module, and principles described in relation to FIGS. 1-14. In this example, the method 1600 includes detecting 1602 a gesture performed above a capacitance sensing strip.

The method 1600 may optionally include determining 1604 if the gesture is detected with a single finger. If the gesture is detected with a single finger, then the method includes initiating 1606 a function keys mode and initiating 1608 a function of a selected function key.

If the gesture does not have a single finger, then the method 1600 may optionally include determining 1610 whether the gesture is detected with two fingers. If the method is determined with two fingers, then the method 1600 may include initiating 1612 a parameter adjustment mode and adjusting 1614 a selected parameter.

If the gesture does not have just two fingers, then the method 1600 may optionally include determining 1616 whether the gesture is detected with three fingers. If the method is determined to have three fingers, then the method 1600 may include initiating 1618 an on-screen mode and interacting 1614 as commanded with a selected object in the display screen.

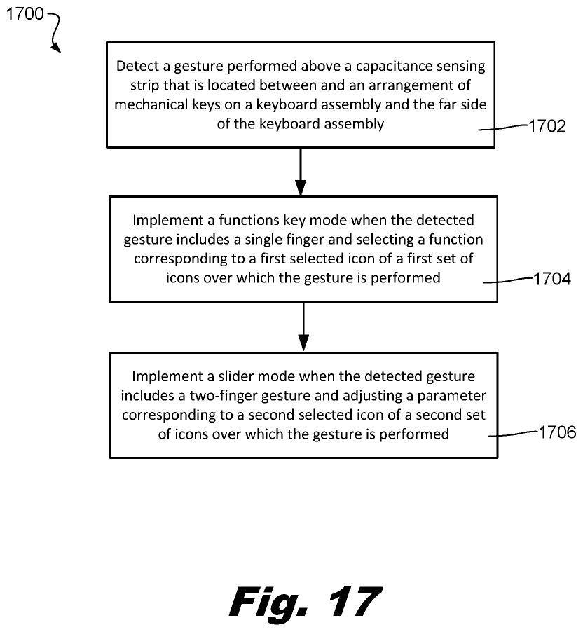

FIG. 17 depicts an example of a method 1700 of using a capacitance sensing strip according to the present disclosure. This method 1700 may be performed based on the description of the devices, module, and principles described in relation to FIGS. 1-14. In this example, the method 1700 includes detecting 1702 a gesture performed above a capacitance sensing strip that is located between and an arrangement of mechanical keys on a keyboard assembly and the far side of the keyboard assembly, implementing 1704 a functions key mode when the detected gesture includes a single finger and selecting a function corresponding to a first selected icon of a first set of icons over which the gesture is performed, and implementing 1706 a slider mode when the detected gesture includes a two-finger gesture and adjusting a parameter corresponding to a second selected icon of second set of icons over which the gesture is performed.

These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a sim card, other smart cards, and various other mediums capable of storing, containing or carrying instructions or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1-20. (canceled)

21. A portable electronic device, comprising:
a display assembly;
a processor;
memory in communication with the processor;
a keyboard assembly;
a connection mechanism connecting a connecting side of the display assembly and to a far side of the keyboard assembly, wherein the display assembly is pivotally movable with respect to the keyboard assembly;
the keyboard assembly comprising an arrangement of mechanical keys;
a capacitance sensing strip located between the arrangement of mechanical keys and the far side of the keyboard assembly;
the capacitance sensing strip comprising:
a first plurality of electrodes aligned in a first direction transverse a length of the capacitance sensing strip and generally spaced at a first interval;
a second plurality of electrodes aligned in a second direction transverse a width of the capacitance sensing strip and generally spaced at a second interval that is shorter than the first interval;
the memory comprising programmed instructions that, when executed, causes the processor to:
detect a gesture performed above the capacitance sensing strip;
respond to the gesture in a first mode when the gesture is detected with a single finger; and
respond to the gesture in a second mode when the gesture is detected with two fingers;
wherein the capacitance sensing strip includes a greater sensitivity to gestures moving perpendicular to the longest dimension of the capacitance strip than along the longest dimension of the capacitance sensing strip.

22. The portable electronic device of claim 21, wherein the first mode or the second mode is a function keys mode where the programmed instructions cause the processor to execute an action based on a selection of a function key in response to detecting the gesture.

23. The portable electronic device of claim 22, wherein at least one icon of a function key is depicted above the capacitance sensing strip.

24. The portable electronic device of claim 23, wherein the least one icon is permanently marked on the keyboard assembly.

25. The portable electronic device of claim 23, wherein the least one icon is not incorporated into a mechanical key and is not part of a virtual display.

26. The portable electronic device of claim 21, wherein the first mode or the second mode is a slider mode where the programmed instructions cause the processor to adjust a parameter associated with the portable electronic device in response to a distance traveled by the gesture over the capacitance sensing strip.

27. The portable electronic device of claim 21, wherein the distance traveled is in a direction transverse the length of the capacitance sensor strip.

28. The portable electronic device of claim 21, wherein the programmed instructions are configured to cause the processor, when executed to respond to the gesture in a third mode when the gesture is detected with a predetermined number of fingers that is greater than two fingers.

29. The portable electronic device of claim 21, further comprising a touch pad incorporated into the keyboard assembly adjacent to the arrangement of mechanical keys.

30. The portable electronic device of claim 29, wherein the processor includes an integrated circuit that processes input from both the touch pad and the capacitance sensing strip.

31. The portable electronic device of claim 29, wherein detecting the gesture with the two fingers includes that the two fingers are from a single hand and the two fingers are positioned together.

32. The portable electronic device of claim 21, wherein the first mode or the second mode is an on-screen mode where programmed instructions cause the processor to interact with an object presented in the display assembly in response to detecting the gesture.

33. The portable electronic device of claim 21, wherein detecting the gesture includes detecting the gesture moving in a direction transverse the length of the capacitance sensing strip.

34. A method of controlling a portable electronic device, comprising:
detecting a gesture performed above a capacitance sensing strip that is located between and arrangement of mechanical keys on keyboard assembly and the far side of the keyboard assembly;
determining a number of fingers used in the gesture;
selecting a mode based on the number of fingers; and
executing an action in the selected mode;
wherein the capacitance sensing strip includes a greater sensitivity to gestures moving perpendicular to the longest dimension of the capacitance strip than along the longest dimension of the capacitance sensing strip.

35. The method of claim 34, wherein the selected mode is a function keys mode and the action includes implementing a function of a selected function key icon in response to detecting the gesture over the selected function key icon.

36. The method of claim 34, wherein at least one icon of a function key is depicted above the capacitance sensing strip.

37. The method of claim 36, wherein the least one icon is permanently marked on the keyboard assembly.

38. The method of claim 36, wherein the least one icon is not incorporated into a mechanical key and is not part of a virtual display.

39. The method of claim 34, wherein the selected mode is a slider mode and the action includes adjusting a parameter associated with a selected parameter in response to a distance traveled by the gesture over the capacitance sensing strip.

40. A computer-program product for controlling a computing device, the computer-program product comprising a non-transitory computer-readable medium storing instructions executable by a processor to:
detect a gesture performed above a capacitance sensing strip that is located between and arrangement of mechanical keys on keyboard assembly and the far side of the keyboard assembly;
implement a functions key mode when the detected gesture includes a single finger and selecting a function corresponding to a first selected icon of a first set of icons over which the gesture is performed; and
implement a slider mode when the detected gesture includes a two-finger gesture and adjusting a parameter corresponding to a second selected icon of a second set of icons over which the gesture is performed;
wherein the first set of icons are mutual exclusive to the second set of icons; and
wherein the first set of icons and the second set of icons are located close enough together that the implementation of the function keys mode or the slider mode prevents a single gesture from triggering icons in both the first set and the second set;
wherein the capacitance sensing strip includes a greater sensitivity to gestures moving perpendicular to the longest dimension of the capacitance strip than along the longest dimension of the capacitance sensing strip.
